(19) United States
(12) Patent Application Publication
(10) Pub. No.: US 2018/0029207 A1
(43) Pub. Date: Feb. 1, 2018

(54) Orthotic Removal Tool

(71) Applicant: Carolyn Hieronymus, McKee, KY (US)

(72) Inventor: Carolyn Hieronymus, McKee, KY (US)

(21) Appl. No.: 15/659,752

(22) Filed: Jul. 26, 2017

Related U.S. Application Data
(60) Provisional application No. 62/368,585, filed on Jul. 29, 2016.

(51) Int. Cl. B25B 27/00; A47G 25/90; A47G 25/82; A43B 17/00

(52) U.S. Cl. CPC B25B 27/00; A43B 17/00; A47G 25/908; A47G 25/82; A43B 7/1405

(57) ABSTRACT

A tool for removing orthotic inserts from inside of a shoe. The tool consists of a blade with a narrow tip for inserting between the edge of the orthotic and the inside of the shoe, a housing attached to the blade, the housing containing an LED light, a battery and an on/off switch to active the light, and a handle use for leverage to remove the orthotic. The handle is covered by a soft pliable rubberized grip made of a silica gel material.

### CROSS REFERENCE TO RELATED APPLICATIONS

This application claims priority to U.S. provisional application Ser. No. 62/368,585 filed on Jul. 29, 2016, and fully incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present invention relates to a small hand held tool use to remove orthotic inserts from shoes.

### Description of the Related Art

Orthotic inserts, commonly referred to as simply “orthotics”, are pad like inserts that are placed on the footbed inside of shoes. Orthotics are used to aid an individual with balance and walking, and a variety of foot related health issues. U.S. Pat. No. 4,597,196, to Brown, describes the orthopedic uses of the orthotic, and the human physiology associated with the use of orthotics, and its teachings are incorporated herein. The orthotic is specifically designed for each individual user. In many cases the orthotic is specially molded to the shape of the bottom of the user's foot. Most people own many pairs of shoes, but will typically only have one or two sets of specially designed orthotics. This is due, in part, to the fact that orthotics can be expensive. As a result the individual will have to remove the set of orthotics from one pair of shoes and insert them into a new pair of shoes, every time the individual wishes to change shoes. This is often quite difficult because the orthotics are designed to fit securely within the shoe.

It is important that the orthotic be securely held within the shoe. If the orthotic slips it could lead to an imbalance of the wearer and potentially lead to a stumble or fall. As a result orthotics are snuggly and securely held within the shoe. Unfortunately, because the orthotic is snuggly inserted into the shoe it can be very difficult to remove the orthotic from the shoe. Orthotics are often commonly worn by the elderly, who frequently have limited dexterity and hand strength. Both make it difficult to remove orthotics from shoes. There is a need, therefore, for a device that will aid in the removal of orthotics from shoes.

### SUMMARY OF THE INVENTION

The present invention is a small hand held tool with a narrow tip that is sized to slid into the shoe and between the edge of the inserted orthotic and the inside edge of the shoe to allow the user to lift up an edge of the orthotic to allow its removal. The tool includes a grip end with soft material to aid in holding the tool. There is an LED light incorporated into the tool so that the removal tool can be used in low light or in a dark room.

### BRIEF DESCRIPTION OF THE DRAWINGS

FIG. 1 is a perspective view of one embodiment of the orthotic removal tool.

FIG. 2 is a perspective view of the orthotic removal tool in use.

FIG. 3 is a perspective view of the orthotic being removed from the shoe.

FIG. 4 is a perspective view of a second embodiment of the invention.

### DETAILED DESCRIPTION OF THE INVENTION

Detailed embodiments of the present invention are disclosed herein. It is to be understood that the disclosed embodiments are merely exemplary of the invention, and that there may be a variety of other alternate embodiments. The figures are not necessarily to scale, and some features may be exaggerated or minimized to show details of particular components. Therefore, specified structural and functional details disclosed herein are not to be interpreted as limiting, but merely as a basis for teaching one skilled in the art to employ the varying embodiments of the present invention.

FIG. 1 is a perspective view of the orthotic removal tool 10 showing most of the components. The orthotic removal tool 10 consists of blade 20 attached to a housing 30 which is attached to a handle 40. In one embodiment the blade 20, housing 30 and handle 40 are made from a single piece of material. In one embodiment the material is a light metal such as aluminum, but in most embodiments it is made of a rigid molded plastic. The blade 20 has a tip 21 that is narrow enough to fit under an orthotic O that is securely fitted into the inside of a shoe S.

The housing 30 has a housing opening 33 on the back side of the tool 10, with a housing cover 34 to securely close the opening 33. (These are not shown in the drawings.) The opening 33 provides access to insert the LED 31, the battery 35 that provides electrical power to operate the LED 31, and the button 32 or on/off switch that turns on and off the LED 31. The LED 31, the battery 35 and the button 32 are electronically attached so that the user can turn on and off the LED 31 by pressing the button 32. In the preferred embodiment the battery 35 is a standard flat watch battery.

The handle 40 is attached to and extends from the housing 30. In one embodiment there is a hole 42 located at the end of the handle 40 to allow the orthotic removal tool 10 to be hung up on a hook or peg, or to attach a string or lanyard. There is a handle cover 41 that is sized to fit and is disposed over the handle 40. The handle cover 41 is made from a soft rubberized material that makes it easier to hold the handle 40 and to manipulate the orthotic removal tool 10. In one embodiment there are a series of ridges 43 that provide additional gripping at the housing end of the handle cover 41. the ridges 43 are located where the user's thumb will typically be placed on the handle. In one embodiment the ridges 43 are positioned directly over the bottom 32 so that the user can activate the LED 31.

In the preferred embodiment the handle cover 41 is made of soft and pliable, yet durable, silica gel, which is known and commonly used for similar purposes. It is sized to fit snugly over the handle 40. With modern production techniques the gel handle cover 41 can be precisely sized to fit snugly and securely over the handle 40. The handle 40 is attached to the blade 20, either directly or in combination with the housing 30, so that the handle 40 provides leverage when the tip 21 is inserted under the orthotic and the orthotic removal tool 10 is used as a lever to dislodge the orthotic O from the inside of the shoe S.

The orthotic removal tool 10 includes a LED 31 and a on-off button 32. The integrated LED 31 serves two separate purposes. First it allows the use of the orthotic removal tool 10 in rooms with low or no light, such as a darkened bedroom where one occupant is sleeping. The user can use the LED 31 as a flashlight to find shoes and orthotics. The LED 31 also allows the user to illuminate the inside of the shoe, which aids in locating a convenient spot to insert the tip 21 between the side of the shoe and the orthotic.

The LED 31 is a standard small LED light. In one embodiment there is a small beveled lens placed over the LED 31 such that the light from the LED 31 is directed toward the tip 31 end of the blade 30. The button 32 can turn on and off the LED 31 in at least two iterations. In one version the button 32 is a pressure sensitive button that only turns on the LED 31 when the button 32 is pressed. In a second embodiment the button 32 is an on-off switch button that turns on with the first push, then turns off with the second push. In a third embodiment the LED 31 includes a light sensitive electric eye diode that will only allow the LED 31 to be illuminated when the area is dark. In a fourth embodiment there is a pressure sensitive switch attached between the blade 20 and the housing 30 that turns on and off the LED when the tip 21 of the blade 20 is twisted when the tip 21 is inserted under the orthotic.

In one embodiment, shown in FIG. 1, the blade 20 is a beveled tetrahedron that narrows from where it attaches to the housing 30 down the tip 21, and also becomes thinner from the housing 30 to the tip 21. In an alternate embodiment, shown in FIG. 4, the blade 20s is a curved, concave, and somewhat spoon shape, which narrows to a curved tip 21a.

In the preferred embodiment the orthotic removal tool 10 is 9 inches long from the tip 21 to the hole 42 end, it is 1½ inches wide and one eighth inch thick. It is understood that the size can vary, but since it is a small hand tool it won't be longer than 12 inches or shorter than 6 inches, nor wider than 2 inches or narrower than one half inch.

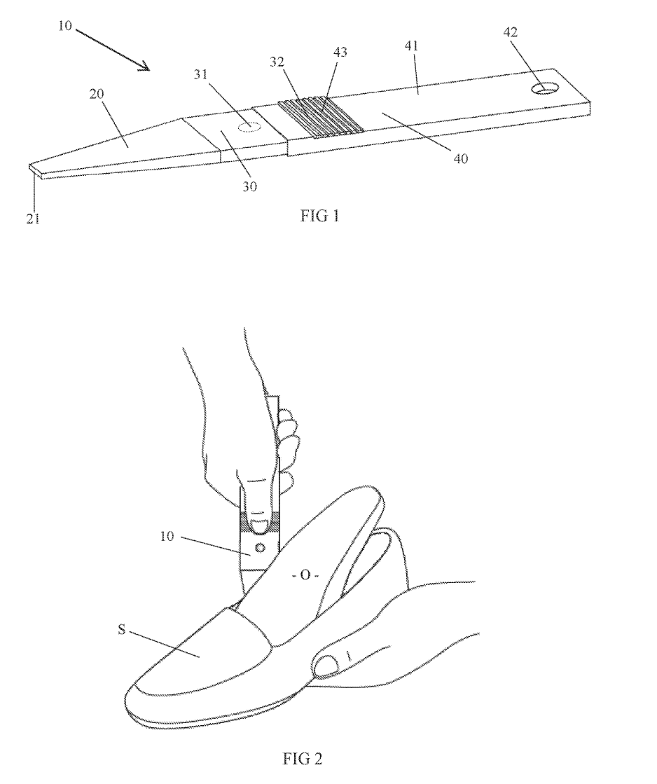

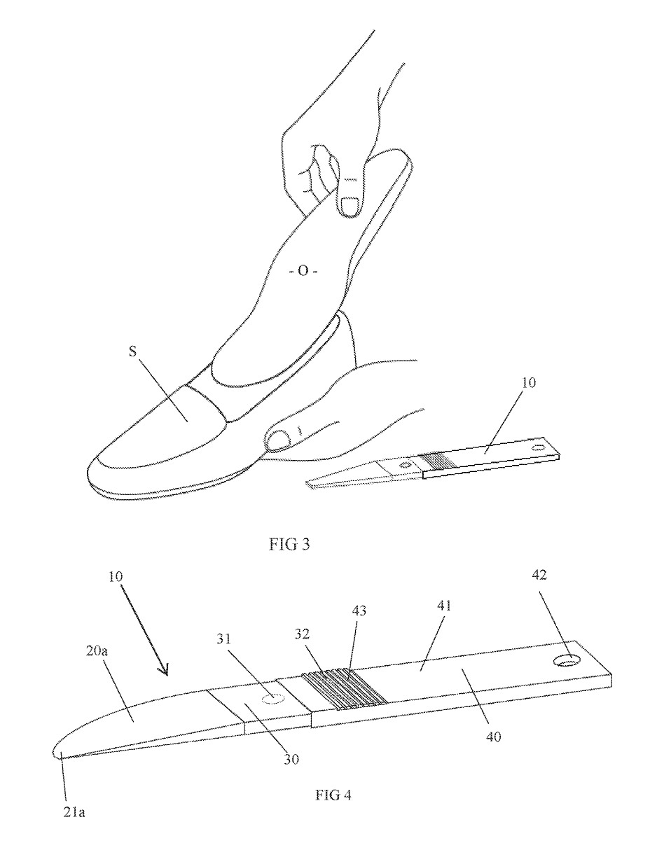

The orthotic removal tool 10 is shown in use in FIG. 2 and FIG. 3. In use the tool 10 is held by the handle 40, and the tip 21 is inserted into the shoe S and between the inside edge of the shoe S and the orthotic O securely inserted therein. The tip 21 is narrow enough to slide between the inside of the shoe S and the orthotic O, but if it is not the shoe S is generally made of a somewhat pliable material such as leather that has some give so that the edge of the shoe S can be pushed away and the tip 21 slid under the orthotic O. The user can use the side of the shoe S as a fulcrum, and the handle 40 as a lever to pry the orthotic O upwards, as shown in FIG. 3. Once the orthotic O is up from the footbed of the shoe S the user can grab the orthotic O itself and remove it entirely from the shoe S as shown in FIG. 4. FIG. 3 shows the orthotic removal tool 10 being inserted under the arch near the middle of the orthotic O, but the tip 21 can be inserted anywhere to pry up the orthotic O.

The present invention is well adapted to carry out the objectives and attain both the ends and the advantages mentioned, as well as other benefits inherent therein. While the present invention has been depicted, described, and is defined by reference to particular embodiments of the invention, such reference does not imply a limitation to the invention, and no such limitation is to be inferred. The depicted and described embodiments of the invention are exemplary only, and are not exhaustive of the scope of the invention. Consequently, the present invention is intended to be limited only by the spirit and scope of the claims, giving full cognizance to equivalents in all respects.

I claim:

1. An orthotic removal tool for removing an orthotic from the inside of a shoe, said orthotic removal tool comprising:
a handle to provide leverage;
a blade attached to said handle, said blade having a tip configured for fitting between an edge of the orthotic and a wall of the inside of the shoe;
wherein said tip is inserted between the edge of the orthotic and the inside wall of the shoe and the handle is used to provide leverage to displace the orthotic to allow its removal.

2. The orthotic removal tool of claim 1 wherein said blade is beveled from said handle to said tip to create a flat end tip.

3. The orthotic removal tool of claim 1 wherein said blade is curved from said handle to said tip to create a curved end tip.

4. The orthotic removal tool of claim 1 further including:
a light integrated into said handle where in said light is positioned to illuminate the tip thereby illuminating the inside of said shoe to aid in locating the edge of said orthotic to aid in removal.

5. The orthotic removal tool of claim 4 wherein said light is an LED.

6. The orthotic removal tool of claim 5 wherein said light includes an on/off switch to activate said light.

7. The orthotic removal tool of claim 6 wherein said on/off switch is pressure sensitive to allow illumination of said light when said on/off switch is pressed.

8. The orthotic removal tool of claim 1 further including:
a handle cover disposed over said handle.

9. The orthotic removal tool of claim 8 wherein said handle cover is made of a silica gel material.

10. The orthotic removal tool of claim 8 wherein said handle cover further includes a thumb grip area with a series of ridges.

11. The orthotic removal tool of claim 6 further including:
a handle cover disposed over said handle.

12. The orthotic removal tool of claim 11 wherein said handle cover is made of a silica gel material.

13. The orthotic removal tool of claim 11 wherein said handle cover further includes a thumb grip area with a series of ridges.

14. The orthotic removal tool of claim 13 wherein said on/off switch is disposed under said thumb grip.

15. The orthotic removal tool of claim 4 further including:
a housing disposed between said blade and said handle, said housing configured to hold said light, said on/off switch, and a battery to power said light.

16. The orthotic removal tool of claim 1 wherein said handle further includes a hole disposed distally from said tip, said hole configured to allow the orthotic removal tool to be stored on a hook, or configured to allow the attachment of a string lanyard.

17. A hand held tool for removing and orthotic from the inside of a shoe, said tool comprising:
a blade having a tip configured for fitting between an edge of the orthotic and a wall of the inside of the shoe
a housing attached to said blade, said housing configured to hold a light, a battery to power said light, and an on/off switch to activate said light;
a handle attached to said housing, said handle having a handle cover disposed thereon, said handle cover made of silica gel material, said handle cover further having a thumb grip area with a series of ridges wherein said thumb grip area is disposed over said on/off switch; and
wherein said tool is used to remove an orthotic from the inside of a shoe by inserting said tip between an edge of the orthotic and an inside wall of the shoe and the handle is used as a lever to displace said orthotic to allow removal from the shoe.
